(19) United States
(12) Patent Application Publication
(10) Pub. No.: US 2013/0238985 A1
(43) Pub. Date: Sep. 12, 2013

(54) METHODS AND DEVICES FOR ELIMINATING CRACKS WITHIN PAGES

(71) Applicants: PEKING UNIVERSITY FOUNDER GROUP CO., LTD., Beijing (CN); BEIJING FOUNDER ELECTRONICS CO., LTD., Beijing (CN)

(72) Inventors: Genglin HUANG, Beijing (CN); Hao LIN, Beijing (CN); Yu TANG, Beijing (CN)

(73) Assignees: BEIJING FOUNDER ELECTRONICS CO., LTD., Beijing (CN); PEKING UNIVERSITY FOUNDER GROUP CO., LTD., Beijing (CN)

(21) Appl. No.: 13/867,887

(22) Filed: Apr. 22, 2013

Related U.S. Application Data
(63) Continuation of application No. PCT/CN2011/081149, filed on Oct. 21, 2011.

(30) Foreign Application Priority Data
Oct. 22, 2010 (CN) 201010515434.7

(51) Int. Cl. G06F 17/21

(52) U.S. Cl. CPC G06F 17/212
USPC 715/244

(57) ABSTRACT

A method for eliminating a crack within a page includes generating two parallel equidistant lines for each contour vector of each of primitives within the page, the two parallel equidistant lines having a predetermined threshold distance and a rectangle equidistance region formed therebetween. The method further includes traversing each of the contour vectors to take a currently traversed contour vector of a primitive as a first contour vector and other contour vectors of another primitive as second contour vectors to determine a location relation between the first contour vector and each of the second contour vectors based on the equidistance region. The method further includes performing a trapping process in an area between the first contour vector and the second contour vectors based on the location relation.

### CROSS REFERENCE OF RELATED APPLICATIONS

This application is a continuation of International Application No. PCT/CN2011/081149, filed on Oct. 21, 2011, which claims the benefit of Chinese Patent Application No. 201010515434.7, filed on Oct. 22, 2010, both of which are incorporated by reference in their entirety.

### TECHNICAL FIELD

This application relates to digital typesetting technology, in particular to a method and a device for eliminating cracks within a page.

### BACKGROUND

Because of mistakes or a limited degree of positioning accuracy in a typesetting process, spatial locations of some primitives in a page appear to be close under a low resolution, but are separated under a high resolution. Such a phenomenon is referred to a crack phenomenon. These cracks may significantly influence the quality of a printed page, in particular, during a trapping process for the page. Specifically, such cracks will obstruct determining whether or not there is a strong color contrast on the same spatial location during the trapping process.

Currently, it is difficult to automatically detect and eliminate the cracks. First, it is difficult to determine a distance between contours of primitives in a page. A minimum distance and a maximum distance between two vectors of straight line segments may be determined by lower order linear equations. However, it is difficult to directly compute the minimum distance and the maximum distance between two vectors, when at least one of the vectors has curved sections. Generally, the distance relation of two vectors may be obtained by using a complex numerical calculation. Second, it is difficult to adjust the contours of the primitives in the page to eliminate cracks between the primitives. It is difficult to adjust the contours of the primitives without changing the original spatial locations of each of the primitives in the adjustment process and to keep the visual effect of the primitives unaffected after the adjusting.

In the art, it has been defined in detail which situation shall be considered as a crack existed in a page. In a common region of two vectors, the distances between each point on one vector of the two vectors and the other vector are determined, and then the maximum distance of these determined distances may be considered as the maximum distance between the two vectors. As shown in FIG. 1, Dist is the maximum distance in the common region between the two vectors L1 and L2.

A crack in a page can be defined as follows. For example, if there are two primitives on the page, if a value of the maximum distance between the vectors constituting the contour of one primitive and the vectors constituting the contour of the other primitive is less than a specified crack threshold, meanwhile the two primitives are separated in a common region in which the maximum distance is less than the specified crack threshold, it means the page has a crack on this spatial location and thus the ground color of the page will be exposed. In actual processing, in the case where the maximum distance is less than the specified threshold, if the two primitives overlap with each other in the common region, it is possible that a color region, of which the color is different from the two primitives, is generated in the common region due to mutual effects of colors of the two primitives, so that the effect is the same as that of the crack in the page. Therefore, the definition for a crack in a page may be simplified as: given there are two primitives on the page, if a value of the maximum distance between the vectors constituting the contour of one primitive (hereinafter, referred to as contour vectors) and the vectors constituting the contour of the other primitive is less than a specified crack threshold, the region in which the maximum distance is located may be considered as having a crack in the page.

As seen in FIG. 1, it is difficult to directly calculate the distance between L1 and L2. In view of the difficulties for automatically detecting and eliminating a crack in a page, a method has been proposed to transform the vectors constituting the contour of each primitive into broken lines, i.e., the vectors constituting the contour of each primitive in the page are transformed into short straight line segments, then the distances between each straight line segment are determined and offset.

However, the above method has a low working efficiency and may not reach perfect effects. First, smoothness of the contour of the primitive is reduced after the curved vectors are transformed into broken lines. If the selected resolution is not high enough in the transforming process and the number of the transformed vectors increases sharply and thus the data size to be processed increases, resulting a lower efficient.

### SUMMARY OF THE APPLICATION

The present application provides a method and a device for eliminating a crack within a page to reduce computation and improve efficiency.

One aspect of the present application provides a method for eliminating a crack within a page. The method may comprise a step of generating two parallel equidistant lines for each contour vector of each of primitives within the page, wherein the two parallel equidistant lines have a predetermined threshold distance and a rectangle equidistance region formed between the generated two equidistant lines. The method may further comprise a step of traversing each of the contour vectors to take a currently traversed contour vector as a first vector and other contour vectors as second vectors, so as to determine a location relation between the first vector and each of the second vectors based on the equidistance region. The method may further comprises determining whether to perform a trapping process in an area between the first vector and the second vectors based on the location relation.

Another aspect of the present application provides a device for eliminating a crack within a page. The device may comprise an equidistance module configured to generate two parallel equidistant lines having a predetermined threshold distance for each contour vector of each of primitives within the page, wherein a rectangle equidistance region formed by the generated two equidistant lines. According to the device, a location module is configured to traverse each of the contour vectors to take a currently traversed contour vector as a first vector and other contour vectors as second vectors, so as to determine a location relation between the first vector and each of the second vectors based on the equidistance region, and a trapping module configured to perform a trapping process based on the location relation.

### BRIEF DESCRIPTION OF THE DRAWING

The following drawings provide further understanding for the present invention, and are a part of the present invention. The exemplary embodiments and description thereof are used to explain the present invention rather than limit the present invention.

FIG. 1 is a diagram illustrating the maximum distance between two vectors.

FIG. 2 is a diagram illustrating a flowchart of a method for eliminating a crack in a page according to one embodiment of the present application.

FIG. 3 is a diagram illustrating a flowchart for determining location relation according to some embodiments of the present application.

FIGS. 4-9 are diagrams illustrating the location relations according to some embodiments of the present application.

FIGS. 10-17 are diagrams illustrating processes for eliminating cracks between primitives in a page according to some embodiments of the present application.

FIG. 18 is a diagram illustrating a device for eliminating a crack in a page according to some embodiments of the present application.

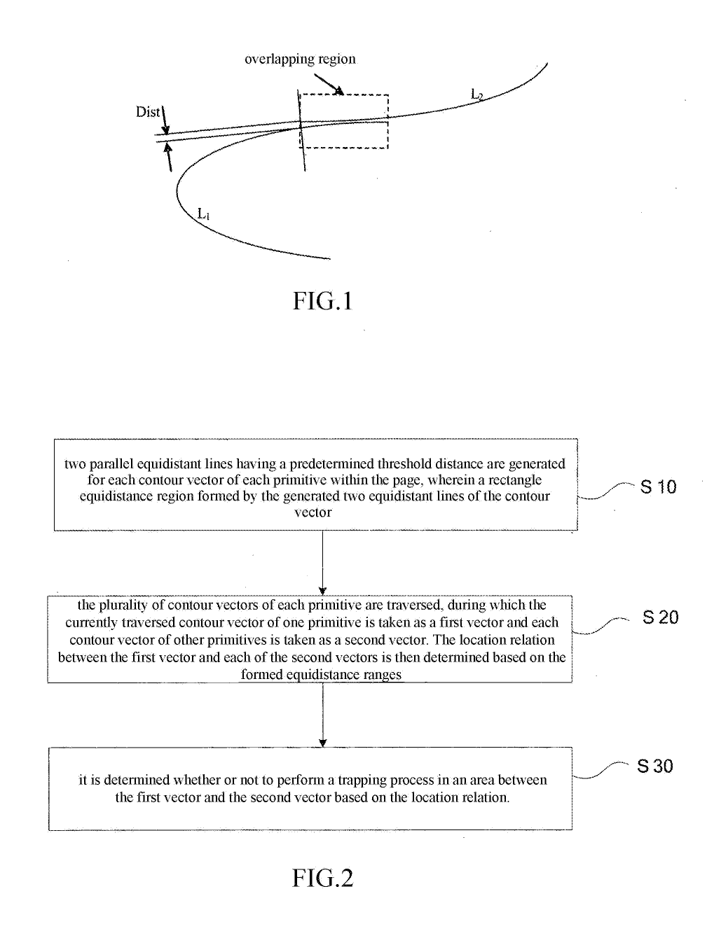

### DETAILED DESCRIPTION

Hereinafter, the embodiments of the present invention will be described in detail with reference to the detailed description as well as the drawings.

FIG. 2 is a diagram illustrating a flowchart of a method for eliminating a crack in a page according to one embodiment of the present application. The method comprises the following processes.

In step 10, two parallel equidistant lines having a predetermined threshold distance (also referred to as distance threshold) are generated for each contour vector of each primitive in the page. A rectangle equidistance region can be formed by the generated two equidistant lines and the two lines crossing two ends (such as the left and right ends) of the contour vector.

In step 20, a plurality of contour vectors of each primitive are traversed. The currently traversed contour vector of one primitive is taken as a first vector and each contour vector of other primitives is taken as a second vector. The location relation between the first vector and each of the second vectors is then determined based on the formed equidistance ranges.

In step 30, it is determined whether or not to perform a trapping process in an area between the first vector and the second vector based on the location relation.

In the conventional technology, the location relation between vectors is determined after the curved vectors are transformed into broken lines, resulting in a complex computation and a lower efficiency. In this embodiment, it is not necessary to transform the contour of each primitive within the page into broken lines, and thus the contour of each primitive in the page is kept smooth. With the equidistance region determination method, it is not needed to compute the distance between two curved vectors. Meanwhile, it is space- and time-efficient since it is not needed to store a large amount of data for the generated large number of vectors during the transforming process. The method creates an equidistance range, and then determines the location relation between vectors based on the equidistance range without transforming vectors into broken lines. Accordingly, the crack within the page may be quickly detected and thus eliminated.

Preferably, before generating parallel equidistant lines, the method further comprises a step of cutting the contour of the primitives at extreme points and turning points thereof to obtain the contour vectors. By this step, it ensures that each contour is monotonic in X direction and Y direction and thus data computation will be reduced.

Hereinafter, the step of traversing will be discussed according to one preferable embodiment of the present application.

First, the ends of each contour vector are ranked in X direction such that the end with a smaller X coordinate is ahead of that with a bigger X coordinate, and the end with a smaller Y coordinate is ahead of that with a bigger Y coordinate if two ends have the same X coordinate. A list for the ranked ends is then established, in which index values in X direction are set for each end in the order of X coordinates, and index values in Y direction are set for each end in the order of Y coordinates.

For each index value within a range between two ends (left and right ends) of each of the first vector and/or the second vector (wherein, the first vector and the second vector respectively are included in contours of two primitives), the location relation between the two vectors is determined using the equidistance region by: obtaining points of intersection between a scanning line and the equidistance region of the first vector so as to obtain the scanning line's Y coordinates range within the equidistance region of the first vector; retrieving end values of the second vector from the list, comparing the retrieved end values of the second vector with the obtained Y coordinate range; determining the retrieved end(s) of the second vector is in the equidistance region of the first vector if the retrieved value(s) of the second vector is located in the Y coordinates range.

The above discussed determination is simple, its logical flow is common and may be implemented completely in a digital process, and thus it is easy to be implemented by computer programs.

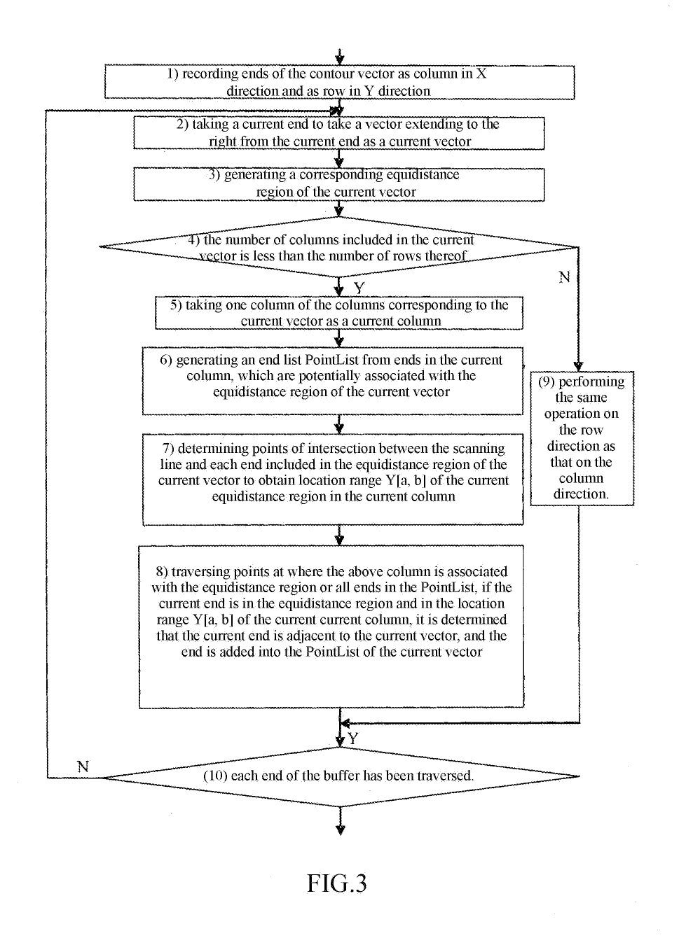

FIG. 3 is a diagram illustrating a flowchart for a method for determining location relation according to one preferable embodiment of the present application. As shown, the method may include:

1) pre-processing contour vectors of each primitive to record ends of the contour vector as column in X direction and as row in Y direction, and mark the column to which each end in the X direction belongs and the row to which each end in Y direction belongs;

2) taking a current end from a list which records each end of the contour vectors of each primitive to take a vector extending to the right from the current end as a current vector;

3) generating a corresponding equidistance region of the current vector according to a predetermined crack threshold;

4) turning to step 9) to operate based on the rows if the number of columns included in the current vector is greater than the number of rows thereof, otherwise turning to step 5) to operate based on the columns as follows;

6) generating an end list PointList from ends in the current column, which are potentially associated with the equidistance region of the current vector;

7) determining points of intersection between the scanning line and the equidistance region of the current vector to obtain location range Y[a, b] of the current equidistance region in the current column;

8) traversing all ends in the PointList, which are located in different primitives from the primitive with the current vector, to compare each traversed end with the location range Y[a, b]; if an end is located in the equidistance region, a new node will be generated in the current vector based on the coordinate of the end; and

10) repeating above steps until the process for each end is done.

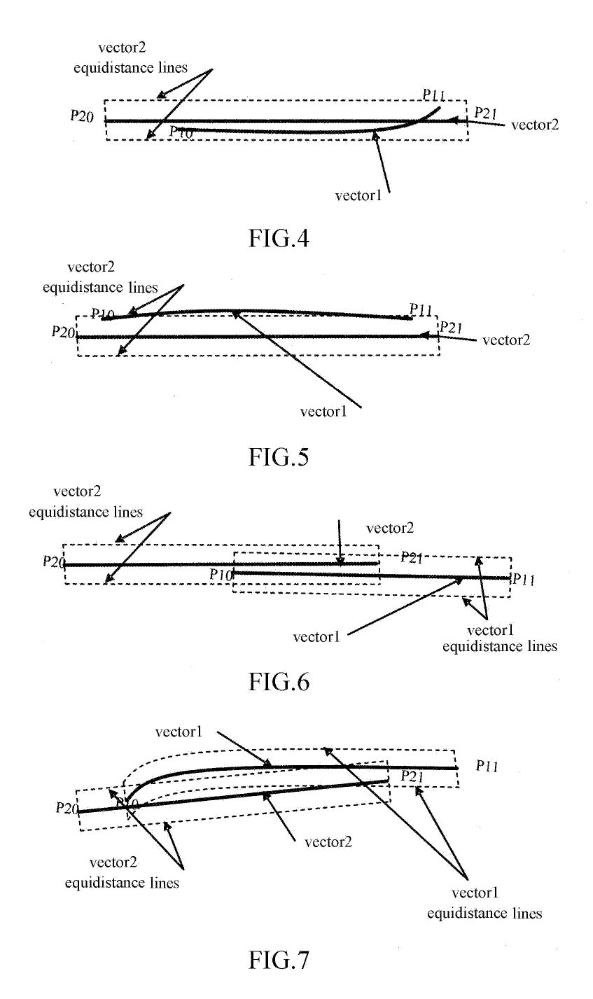

FIGS. 4-9 are diagrams illustrating the location relations according to one preferable embodiment of the present application. The location relation to be determined between a first vector (vector 1) and a second vector (vector 2) (the first vector and the second vector are respectively included in two primitives, as shown) based on the equidistance region may comprise:

Location relation 1 shown in FIG. 4: two ends of vector 1 are in the equidistance region of the vector 2, and there is no intersection point between vector 1 and the equidistance lines of vector 2;

Location relation 2 shown in FIG. 5: two ends of vector 1 are in the equidistance region of the vector 2, and there is at least one intersection point between vector 1 and the equidistance lines of vector 2;

Location relation 3 shown in FIG. 6: only one end of vector 1 is in the equidistance region of the vector 2, only one end of vector 2 is in the equidistance region of the vector 1, and there is no intersection point between vector 1 and the equidistance lines of vector 2;

Location relation 4 shown in FIG. 7: only one end of vector 1 is in the equidistance region of the vector 2, only one end of vector 2 is in the equidistance region of the vector 1, and there is at least one intersection point between vector 1 and the equidistance lines of vector 2;

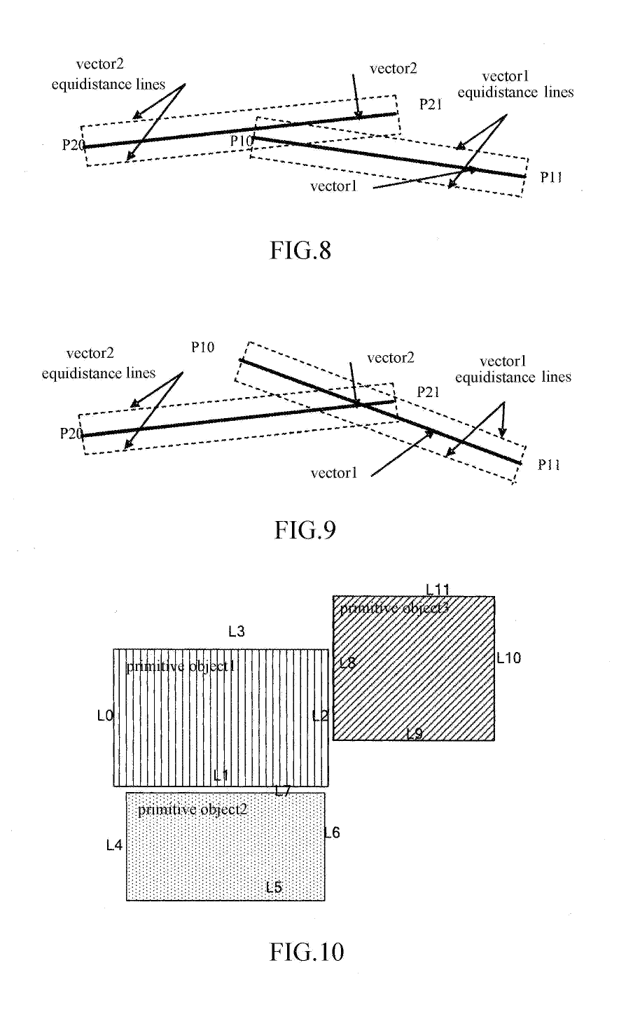

Location relation 5 shown in FIG. 8: only one end of vector 1 is in the equidistance region of the vector 2, and none of ends of vector 2 is in the equidistance region of the vector 1; and

Location relation 6 shown in FIG. 9: none of ends of vector 1 is in the equidistance region of the vector 2, and none of ends of vector 2 is in the equidistance region of the vector 1.

Preferably, in step 30, for the location relations 2, 4, 5 and 6, the trapping process is not required to be performed on the range between the first vector and the second vector; for the location relations 1 and 3, the trapping process is performed in the area formed between the first vector and the second vector. Each of the location relations 2, 4, 5 and 6 indicate that the maximum distance between two vectors is greater than the equidistance threshold, and thus it is determined that there is no crack between the first vector and the second vector and thus the trapping process is not required. Each of the location relations 1 and 3 indicate that the maximum distance between two vectors is less than the equidistance threshold, and thus it is determined that there is a crack between the first vector and the second vector and the trapping process is required.

According to the above embodiment, the computation is reduced compared with the conventional methods and the speed for determining a crack in a page is improved since only 6 location relations need to be determined.

Preferably, for the location relation 1, in the step of performing the trapping process between the first vector and the second vector (the first vector and the second vector are respectively included in two primitives), points A and B are determined on the first vector (wherein points A and B respectively correspond to two ends included in the second vector) and the second vector is moved to completely overlap with the vector AB between the two points A and B. As shown, the term “correspond” means that a point A is a projected end on the first vector from a corresponding end of the second vector along its normal. In this preferable embodiment, points A and B in the first vector are set as coincident points, but the invention is not limited to this manner, and two ends of the second vector may be set as coincident points.

Preferably, for the location relation 3, in the step of performing the trapping process between the first vector and the second vector, a point A is determined on the first vector. Point A may correspond to an end X included in the second vector. A point Y is determined on the second vector. Point Y may correspond to an end B included in the first vector. The second vector is moved to completely overlap with the vector AB between the two points A and B. In this preferable embodiment, points A and B are set as coincident points, but the invention is not limited by this manner, and points X and Y may be set as coincident points.

In this step, each coincident point is traversed from the left to the right and from the top to the bottom following the location for each coincident point, and then vectors associated with each coincident point is adjusted. The principle of the adjustment is as follows: if ends of a vector and a segment vector respectively locate on the location of the same coincident point, meanwhile, the distance relation of two vectors is in the crack state, the two vectors or two segment vectors are adjusted to completely overlap each other, i.e., to form a coincident vector; and all of the subsequent operations to be performed on the coincident vector will be performed on the two vectors constituting of the coincident vector at the same time.

The method for performing a trapping process on the crack in the above embodiment is simple since it is just needed to move the vector segments to form coincident vectors.

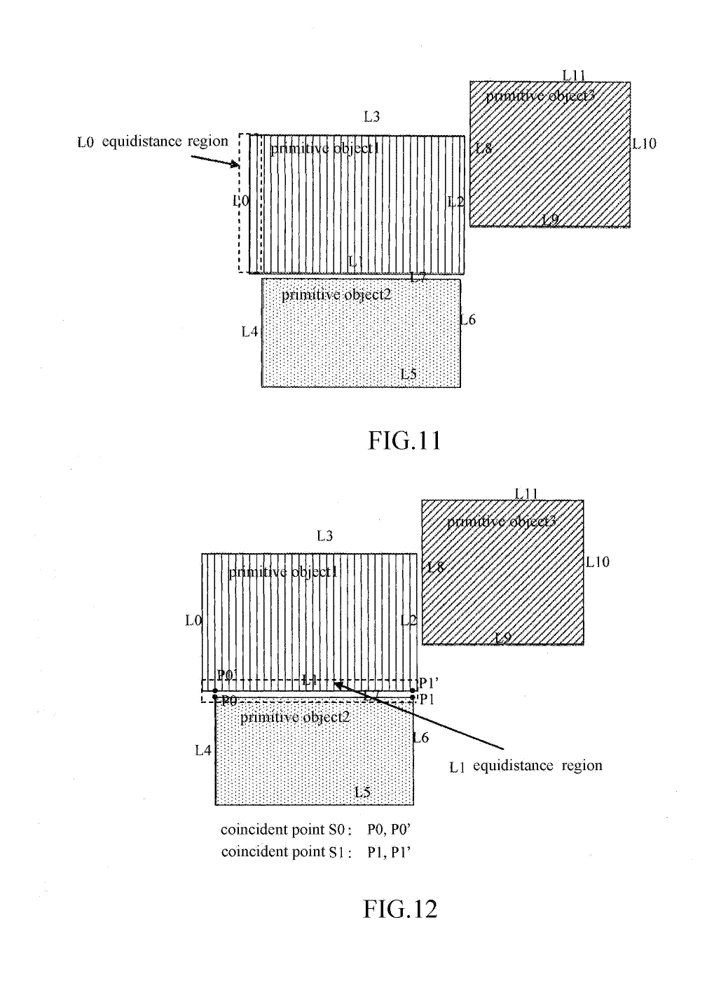

FIGS. 10-16 are diagrams illustrating a process for eliminating a crack between primitives within a page according to one preferable embodiment of the present application.

As shown in FIG. 10, there are three primitive objects 1-3 on a certain page, and the locations thereof are not fully matched and there are small cracks, as shown in FIG. 10.

After ends of vectors of each object's contour on the page are ranked, the vector on the leftmost side is processed first, as shown in FIG. 11. After the equidistance region of L0 is generated based on a predetermined crack distance threshold, it may be seen that none of ends of other objects is located in the equidistance region of L0.

Next, the vector L1 on the leftmost side in the remaining vectors is processed, as shown in FIG. 12. After the equidistance region of L1 is generated, it may be seen that two ends P0 and P1 of vector L7 are located in the equidistance region of L1. Therefore, two new notes respectively corresponding to locations of P0′ and P1′ are generated on the vector L1, wherein, P0 and P0′ form a coincident point S0, and P1 and P1′ form a coincident point S1.

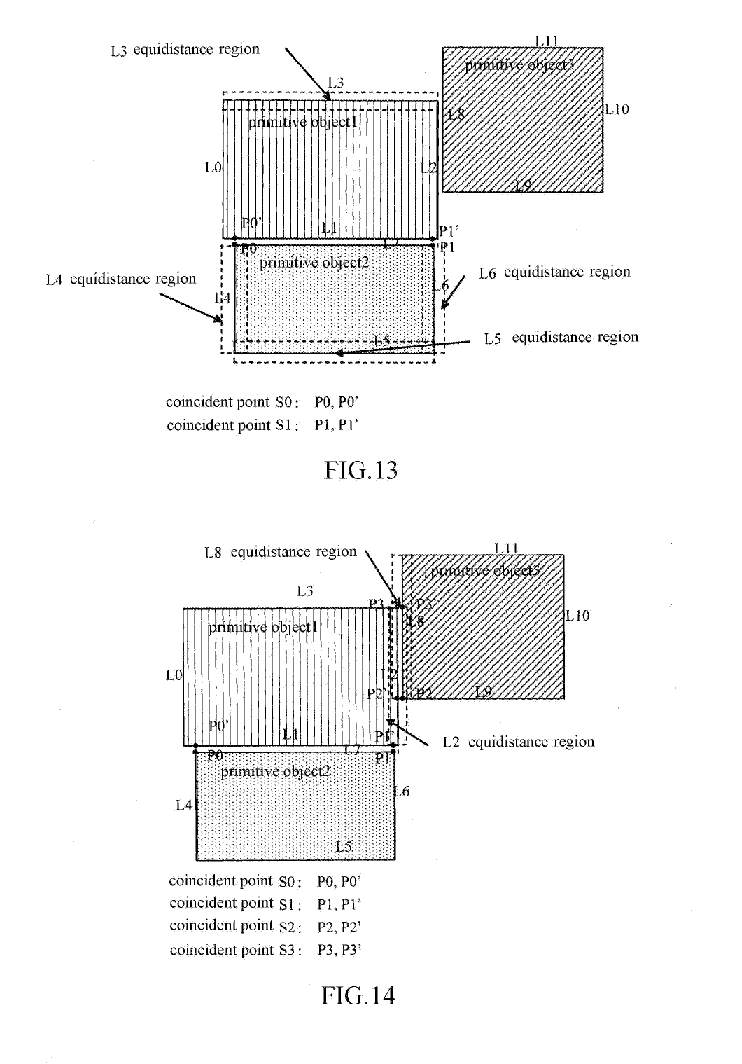

The same process is performed on the vectors L3, L4, L5 and L6 after the process for vector L1 is finished, and it may be seen that none of ends of the other objects are in respective equidistance regions of the vectors L3, L4, L5 and L6, as shown in FIG. 13.

However, for the vectors L2 and L8, as shown in FIG. 14, an end P3 of vector L2 is in the equidistance region of vector L8, and therefore, a new note P3′ is generated on the vector L8 to correspond to the end P3, wherein, P3 and P3′ form a coincident point S3. An end P2 of vector L8 is in the equidistance region of vector L2, and therefore, a new note P2′ is generated on the vector L2 to correspond to the end P2, wherein P2 and P2′form a coincident point S2.

Next, each remaining vector is processed. For the vectors L9, L10, L11 and L12, it may be seen that none of ends of other objects are in their equidistance regions, as shown in FIG. 15.

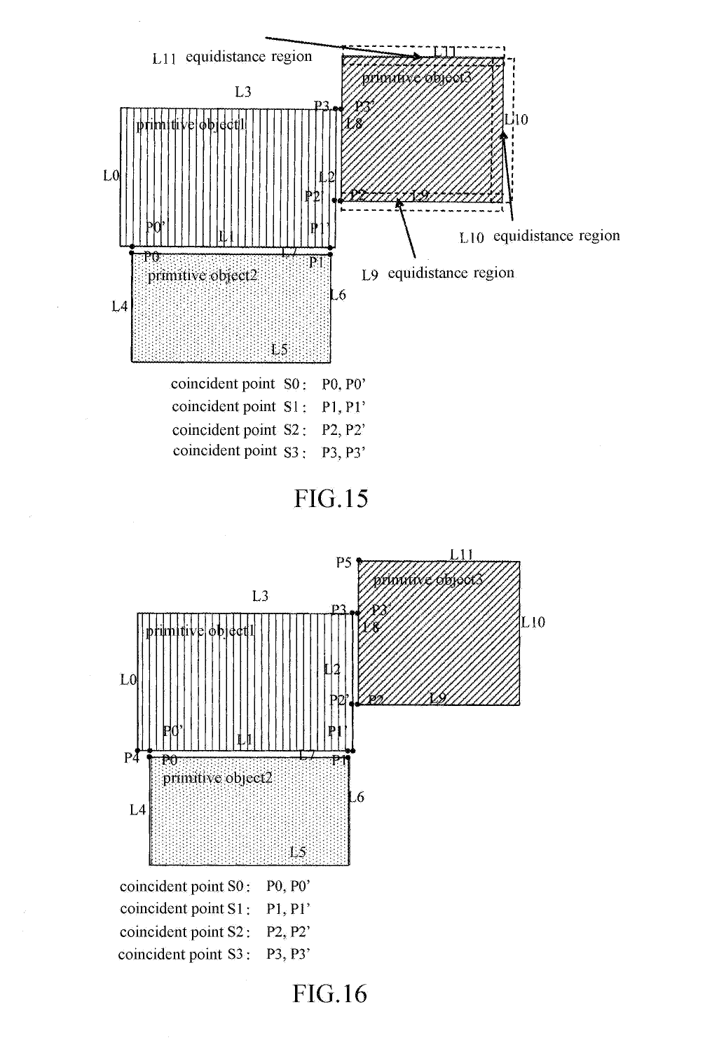

As shown in FIG. 16, after all of coincident points are generated, the relations between each two vectors is determined according to the generated coincident points, which comprises:

for the coincident point S0: the vectors associated with the coincident point S0 includes vectors P4P0′, P0′P1′, L4 and L7; it is determined that the relation between vectors L7 and P0′P1′ meet with the location relation 1, and therefore, there is a crack between vectors L7 and P0′P1′;

for the coincident point S1: each of the right side (top side) vectors associated with the coincident point S1 does not meet the crack relation;

for the coincident point S2: the relation between vectors P2′P3 and P2P3′ meet with the type 3 vector relation, and therefore, there is a crack between vectors P2′P3 and P2P3′.

for the coincident point S3: each of the right side (top side) vectors associated with the coincident point S3 does not meet the crack relation.

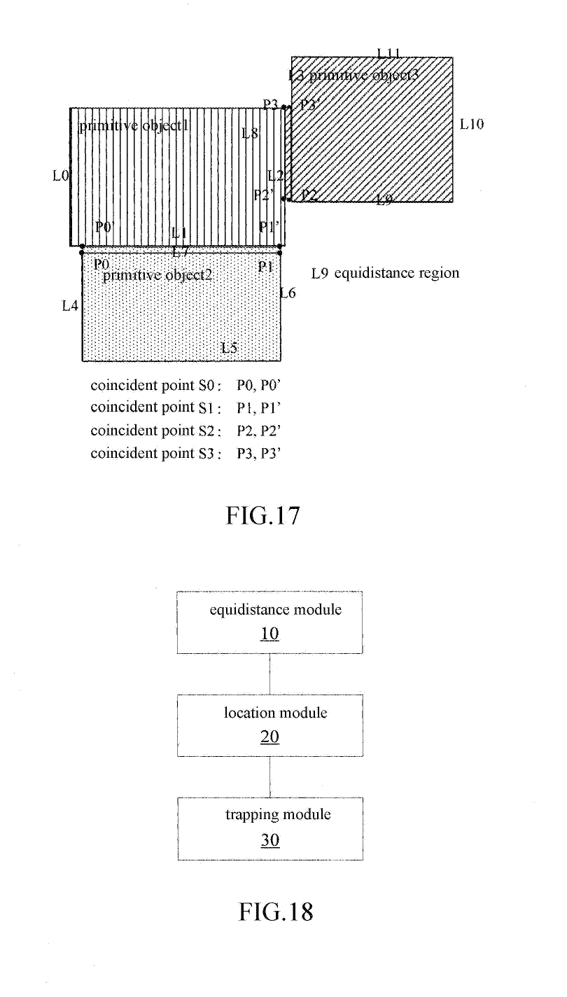

After the determination for all vectors is done, the vectors with the crack relation are adjusted. As shown in FIG. 17, the vector L1 is moved to the location of the vector P0′P1′ and the vector P2P3′ is moved to the location of the vector P2′P3.

FIG. 18 is a diagram illustrating the device for eliminating the crack within the page according to one embodiment of the present application. The device comprises an equidistance module 10 configured to generate two parallel equidistant lines having a predetermined threshold distance (also referred to as distance threshold) for each contour vector of each primitive within the page, wherein a rectangle equidistance region formed by the generated two equidistant lines and the two lines crossing two ends (such as the left and right ends) of the contour vector.

The device further comprises a location module 20 and a trapping module 30. The location module 20 is configured to traverse the plurality of contour vectors of each primitive, during which the currently traversed contour vector of one primitive is taken as a first vector and each contour vector of other primitives is taken as a second vector. The location relation between the first vector and each of the second vectors is then determined based on the formed equidistance ranges. The trapping module 30 is configured to determine whether or not to perform a trapping process in an area formed between the first vector and the second vector based on the location relation.

The device according to the embodiment may simply and quickly detect a crack within a page, so that the crack may be eliminated.

Preferably, the location relations to be determined by the location module comprise: Location relation 1 shown in FIG. 4: two ends of vector 1 are in the equidistance region of the vector 2, and there is no intersection point between vector 1 and the equidistance lines of vector 2;

Location relation 2 shown in FIG. 5: two ends of vector 1 are in the equidistance region of the vector 2, and there is at least one intersection point between vector 1 and the equidistance lines of vector 2;

Location relation 3 shown in FIG. 6: only one end of vector 1 is in the equidistance region of the vector 2, only one end of vector 2 is in the equidistance region of the vector 1, and there is no intersection point between vector 1 and the equidistance lines of vector 2;

Location relation 4 shown in FIG. 7: only one end of vector 1 is in the equidistance region of the vector 2, only one end of vector 2 is in the equidistance region of the vector 1, and there is at least one intersection point between vector 1 and the equidistance lines of vector 2;

Location relation 5 shown in FIG. 8: only one end of vector 1 is in the equidistance region of the vector 2, and none of ends of vector 2 is in the equidistance region of the vector 1; and

Location relation 6 shown in FIG. 9: none of ends of vector 1 is in the equidistance region of the vector 2, and none of ends of vector 2 is in the equidistance region of the vector 1.

As to the location relation 2, 4, 5 and 6, the trapping module does not perform the trapping process in the area formed between the first vector and the second vector, while for the location relation 1 and 3, the trapping module performs the trapping process in the area formed between the first vector and the second vector.

According to the above embodiment, the computation is reduced compared with the conventional methods and the speed for determining the crack within the page is improved since only 6 location relations need to be determined.

Preferably, the trapping module 30 may further comprise a first module configured to determine points A and B on the first vector for the location relation 1, wherein points A and B respectively correspond to two ends in the second vector, wherein, the first vector and the second vector are respectively included in two primitives. The trapping module 30 further comprises a second module configured to determine a point A on the first vector and determine a point Y on the second vector for the location relation 3, wherein, the point A corresponds to the end X included in the second vector, the point Y corresponds to an end B included in the first vector, and an adjusting module configured to make the vector XY in the second vector be moved to completely overlap with the vector AB.

The device for performing the trapping process on the crack in the above embodiment becomes simple by offsetting the coincident vector segments.

It may be seen from the above that the computation for the maximum distance between curved vectors is simplified to determine the points of intersection between curved vectors, and thus the crack within the page may be simply and quickly detected.

It will be readily apparent to those skilled in the art that the modules or steps of the present application may be implemented with a common computing device. In addition, the modules or steps of the present application may be concentrated or run in a single computing device or distributed in a network composed of multiple computing devices. Optionally, the modules or steps may be achieved by using codes of an executable program. The codes may be stored in the storage medium, and can be executed by a processor to perform the recited steps and implement the modules. The plurality of the modules or steps may also be fabricated into an individual integrated circuit module. Therefore, the present application is not limited to any particular hardware, software or combination thereof.

The foregoing is only preferred embodiments of the present application, and it is not intended to limit the present application. Any modifications, equivalent substitutions, improvements etc. within the spirit and principle of the present application should be included within the scope of protection of the application.

What is claimed is:

1. A method for eliminating a crack in a page having at least a first primitive and a second primitive, comprising:
generating a plurality of contour vectors on a contour of each of the primitives;
generating two parallel equidistant lines having a predetermined threshold distance for each contour vector of each of the primitives within the page, wherein a rectangle equidistance region is formed by the two generated equidistant lines;
determining a location relation between a first contour vector of the first primitive and one or more of second contour vectors of the second primitive based on the equidistance region;
determining whether to perform a trapping process in an area between the first contour vector and the one or more of the second contour vectors based on the location relation; and
if the determination is yes, performing the trapping process.

2. A method according to claim 1, wherein each of the contour vectors is monotonic in X direction and Y direction.

3. A method according to claim 1, wherein the generating a plurality of contour vectors comprises:
cutting points of the contour of each of the primitives to obtain the contour vectors that are monotonic in X direction and Y direction.

4. A method according to claim 1, wherein determining a location relation between the first contour vector and the one or more of the second contour vectors based on the equidistance region comprises:
determining whether ends of the one or more of the second contour vectors are within the equidistance region.

5. A method according to claim 4, wherein determining whether ends of the one or more of the second contour vectors are within the equidistance region comprises:
scanning the equidistance region of the first contour vector with a scanning line to obtain points of intersection between the scanning line and the equidistance region of the first contour vector;
retrieving coordinate values in Y direction of ends of a second contour vector;
comparing the retrieved coordinate values of the ends of the second contour vector with a range of coordinate values in Y direction of the obtained points of intersection; and
determining the ends of the second contour vector are in the equidistance region of the first contour vector if the coordinate values of the ends of the second contour vector fall in the range of coordinate values.

6. A method according to claim 1, wherein determining a location relation between the first contour vector and the one or more of the second contour vectors based on the equidistance region comprises:
determining whether the first contour vector and a second contour vector are in relation 1, where two ends of the first contour vector fall in an equidistance region of a second contour vector, and there is no intersection point between the first contour vector and the equidistance lines of the second contour vector;
and if the determination is yes, determining to perform the trapping process in an area between the first contour vector and the second contour vector.

7. A method according to claim 1, wherein determining a location relation between the first contour vector and the one or more of the second contour vectors based on the equidistance region comprises:
determining whether the first contour vector and a second contour vector are in relation 2, where two ends of the first contour vector are in an equidistance region of a second contour vector, and there is at least one intersection point between the equidistance lines of the first contour vector and the equidistance lines of the second contour vector;
and if the determination is yes, determining not to perform the trapping process in an area between the first contour vector and the second contour vector.

8. A method according to claim 1, wherein determining a location relation between the first contour vector and the one or more of the second contour vectors based on the equidistance region comprises:
determining whether the first contour vector and a second contour vector are in relation 3, where only one end of the first contour vector fall in an equidistance region of a second contour vector, only one end of the second contour vector is in the equidistance region of the first contour vector, and there is no intersection point between the equidistance lines of the first contour vector and the second contour vector;
and if the determination is yes, determining to perform the trapping process in an area between the first contour vector and the second contour vector.

9. A method according to claim 1, wherein determining a location relation between the first contour vector and the one or more of the second contour vectors based on the equidistance region comprises:
determining whether the first contour vector and a second contour vector are in relation 4, where only one end of the first contour vector is in an equidistance region of a second contour vector, only one end of second contour vector is in the equidistance region of the first contour vector, and there is at least one intersection point between the equidistance lines of the first contour vector and the second contour vector;
and if the determination is yes, determining not to perform the trapping process in an area between the first contour vector and the second contour vector.

10. A method according to claim 1, wherein determining a location relation between the first contour vector and the one or more of the second contour vectors based on the equidistance region comprises:
determining whether the first contour vector and a second contour vector are in relation 5, where only one end of the first contour vector is in an equidistance region of a second contour vector, none of ends of the second contour vector is in the equidistance region of the first contour vector;
and if the determination is yes, determining not to perform the trapping process in an area between the first contour vector and the second contour vector.

11. A method according to claim 1, wherein determining a location relation between the first contour vector and the one or more of the second contour vectors based on the equidistance region comprises:
determining whether the first contour vector and a second contour vector are in relation 6, where none of ends of the first contour vector is in an equidistance region of a second contour vector and none of ends of the second contour vector is in the equidistance region of the first contour vector;
and if the determination is yes, determining not to perform the trapping process in an area between the first contour vector and the second contour vector.

12. A method according to claim 1, further comprising:
determining points A and B on the first contour vector, wherein the points A and B are two projected points on the first contour vector from two ends of a second contour vector, and
moving the second contour vector to overlap with a vector AB formed between points A and B.

13. A method according to claim 1, further comprising:
determining a point A on the first contour vector and a point Y on the second contour vector, wherein the point A is a projected point on the first contour vector from an end X of the second contour vector, the point Y is a projected point on the second contour vector from an end B of the first contour vector; and
moving the second contour vector such that the points A and B overlap with the points X and Y, respectively.

14. A device for eliminating a crack within a page, the page having at least a first primitive and a second primitive, the device comprising:
an equidistance module configured to form a plurality of contour vectors and generate two parallel equidistant lines having a predetermined threshold distance for each of the formed contour vectors, wherein a rectangle equidistance region is formed by the two generated parallel equidistant lines and two lines crossing two ends of the contour vector respectively;
a location module configured to locate a crack between a first contour vector of the first primitive and a second contour vector of the second primitive; and
a trapping module configured to eliminate the located crack.

15. A device according to claim 14, wherein each of the formed vectors is monotonic in X direction and Y direction.

16. A device according to claim 14, wherein the equidistance module is further configured to cut points of a contour of each of the primitives to make each of the contour vectors monotonic in X direction and Y direction.

17. A device according to claim 14, wherein the location module is further configured to:
scan the equidistance region of the first contour vector using a scanning line to obtain points of intersection between the scanning line and the equidistance region of the first contour vector;
retrieve coordinate values in Y direction of ends of a second contour vector;
compare the retrieved coordinate values of the ends of the second contour vector with a coordinate range in Y direction of the points of intersection; and
determine the retrieved values of the ends of the second contour vector is in the equidistance region of the first contour vector if the retrieved values of the ends of the second contour vector are within the coordinate range in Y direction.

18. A device according to claim 14, wherein the trapping module comprises:
a first module configured to determine points A and B on the first contour vector, wherein the points A and B are two projected points on the first contour vector from two ends of a second contour vector; and
an adjusting module configured to move the second contour vector to overlap with a vector AB formed between points A and B.

19. A device according to claim 14, wherein the trapping module comprises:
a second module configured to determine a point A on the first contour vector and determine a point Y on a second contour vector, wherein the point A is a projected point on the first contour vector from an end X of the second contour vector, the point Y is a projected point on the second contour vector from an end B of the first contour vector; and
an adjusting module configured to move the second contour vector such that the points A and B overlap with the points X and Y respectively.

20. A method for determining a crack within a page having at least a first primitive and a second primitive, comprising:
cutting a contour of each of the primitives to form a plurality of contour vectors;
generating two parallel equidistant lines having a predetermined threshold distance for each of the contour vectors of each primitive, wherein a rectangle equidistance region is formed by the two parallel equidistant lines and two lines crossing two ends of the contour vector respectively; and
scanning the rectangle equidistance region to determine if there is a crack between a first contour vector of the first primitive and a second contour vector of the second primitive.
